(19) United States
(12) Patent Application Publication
(10) Pub. No.: US 2004/0128647 A1
(43) Pub. Date: Jul. 1, 2004

(54) System safety metrics process

(76) Inventor: James M. Gibbons, E. Norristown, PA (US)

Correspondence Address: Frank J. Bozzo, Esq., BLACK LOWE & GRAHAM PLLC, 816 Second Avenue, Seattle, WA, 98104, US

(21) Appl. No.: 10/335,746

(22) Filed: Dec. 31, 2002

(51) Int. Cl. G06F 9/44

(52) U.S. Cl. 717/104; 717/101; 717/120

(57) ABSTRACT

A method and system for improving system safety are disclosed. A system safety plan is created, part of which involves making a preliminary hazard assessment of hazards that potentially arise in the product evolution project. As part of the system safety plan, a hazard control plan is created to minimize the potential hazards identified. To monitor the system safety plan or choose between alternative control plans, a metric program measurement standard is created. As the system safety plan is implemented, hazard events that occur are investigated. The hazard events are tracked so that the system safety plan suitably is evaluated according to the metric program measurement standard previously created. A review process is initiated when the system safety plan fails to meet objectives or the product evolution project yields safety concerns not considered in the system safety plan.

### FIELD OF THE INVENTION

This invention relates generally to system safety programs and, more specifically, to measuring effectiveness of system safety programs.

### BACKGROUND OF THE INVENTION

Safety of people who create, install, and use products, and protection of equipment and the environment are enormous concerns. A paramount concern is that people are not injured, for the sake of their health and wellbeing. A second, more pragmatic concern is the cost that results from mishaps in which people, equipment, and/or the environment are harmed. A mishap can result in medical costs, lost time for the injured person and the company, forensic investigatory costs, increased insurance costs, legal fees and damage awards, and other wasteful costs. Certainly, avoidance of mishaps is a wholly worthwhile objective.

While importance of safety is not questioned, how best to ensure safety can be difficult. One particularly difficult task is the setting of useful goals for safety program. Traditionally, safety goals may have consisted only out of statements such as “we do not want to have any serious accidents,” or “this new product evolution project should not present any more hazards than its predecessor program.” What such simplistic objectives may fail to do is to encourage any predictive effort to identify hazards and their controls before mishaps occur. Similarly a simple mandate that there being no catastrophic or higher risk hazards in the program may merely discourage accurate mishap or hazard event reporting to appear to comply with that initial mandate. These approaches may result in an after-the-fact assessment that the safety objectives were met in some sense, even though the program may not have been as safe as it was believed to be, or even safe at all.

Another related problem is measuring safety programs to determine their effectiveness. Metrics have been used to evaluate the effectiveness of safety engineers. Unfortunately, most of the metrics used tend only to characterize mishaps as action items to be reviewed, perhaps tallied, and then possibly forgotten. Moreover, most of the measurement that takes place has to do with the length of time a mishap investigation has been open without resolution, rather than measuring whether any effort was made to avoid the mishap or to prevent similar, future mishaps.

Thus, there is an unmet need in the art for a system and the method for improving the quantitative and qualitative assessment of risks and assessment of safety programs.

### SUMMARY OF THE INVENTION

The present invention provides a method and system for establishing and evaluating a safety program in a product evolution project. The safety program calls for a prospective assessment of potential hazards, and plans are made to try to minimize the risks identified. As product evolution continues from design through implementation, the effectiveness of preventative safety measures and the program's response to mishaps that occur are monitored according to a metric measurement standard to evaluate overall safety. Overall, it is an object of the present invention to be able to measure how much the overall system safety program has shifted the risk level, and to determine whether the program is utilizing optimal hazard controls at each phase of the product evolution project.

An exemplary embodiment of the present invention begins with opening a system safety plan. As part of a preliminary hazard assessment, hazards that potentially arise in the product evolution project are identified. As part of the system safety plan, a hazard control is created for each identified hazard to minimize the risk associated with the hazard. To compare alternative safety control plans and/or hazard controls and monitor the effectiveness of the safety control plan, a metric program measurement standard is created. As the product evolution project continues, mishaps that occur are investigated. The mishaps are tracked so that the system safety control plan can be evaluated according to the metric program measurement standard previously created.

Embodiments of the present invention may call for demonstrated concurrence of stakeholders having an interest in or control over the program. Embodiments of the invention may also call for identification of critical and subcritical safety nodes where mishaps are most clearly foreseen or where the most severe injuries or other harms might be inflicted. Also, embodiments of the invention may be iteratively modified to improve the system safety plan as previously-unforeseen hazards are identified, or as better hazard controls are identified. In addition, the metric program measurement standard uses a risk assessment decision matrix in which a risk assessment-code is assigned for hazards that have been completely eliminated to that alternative system safety plans quantitatively can be fully compared. A review process is initiated when the system safety plan fails to meet objectives or the product evolution project yields safety concerns not considered in the system safety plan. As determined by the review process, previously proposed alternative measures can be implemented, new or additional resources applied, design team communication increased, new measures developed, and/or the project can be cancelled or postponed until corrective action becomes available to eliminate unacceptable levels of risk.

### BRIEF DESCRIPTION OF THE DRAWINGS

The preferred and alternative embodiments of the present invention are described in detail below with reference to the following drawings.

FIG. 1 is a flowchart of a product evolution project for product and process development incorporating a system safety metrics process of an embodiment of the present invention;

FIG. 2 is a flowchart of a concept development process incorporating relevant phases of a system safety metrics process of an embodiment of the present invention;

FIG. 3 is a flowchart of a detailed design process incorporating relevant phases of a system safety metrics process of an embodiment of the present invention;

FIG. 4 is a flowchart of a testing and evaluation process incorporating relevant phases of a system safety metrics process of an embodiment of the present invention;

FIG. 5 is a flowchart of a deployment and operations process incorporating relevant phases of a system safety metrics process of an embodiment of the present invention; and

FIG. 6 is a flowchart of a review process undertaken when system safety program objectives are not met.

### DETAILED DESCRIPTION OF THE INVENTION

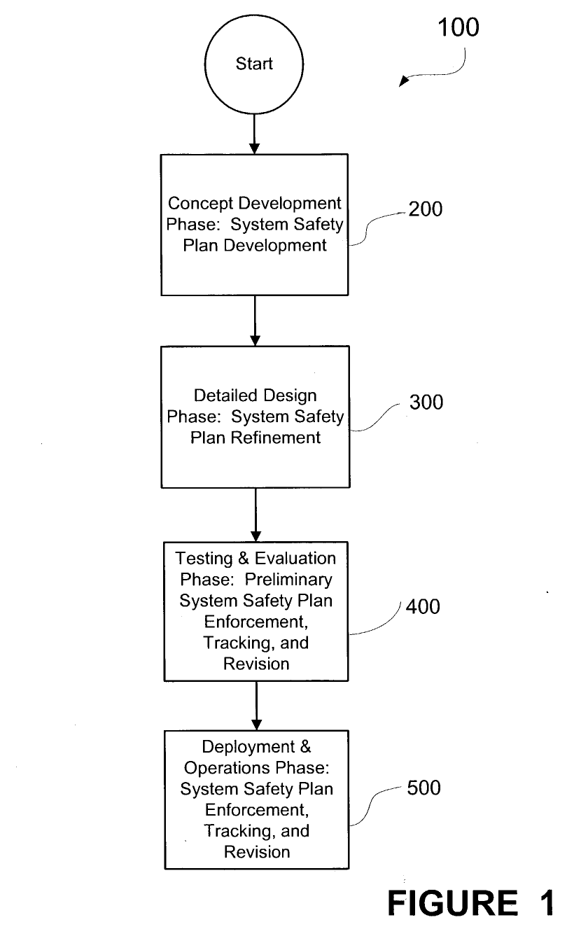

FIG. 1 is a flowchart of a product evolution project 100 for product and process development. The phrase “product evolution project” or “project” will be used throughout the remainder of this description. However, the procedures herein described could be used equally well with product design, manufacturing, testing, and assembly processes or in performing services.

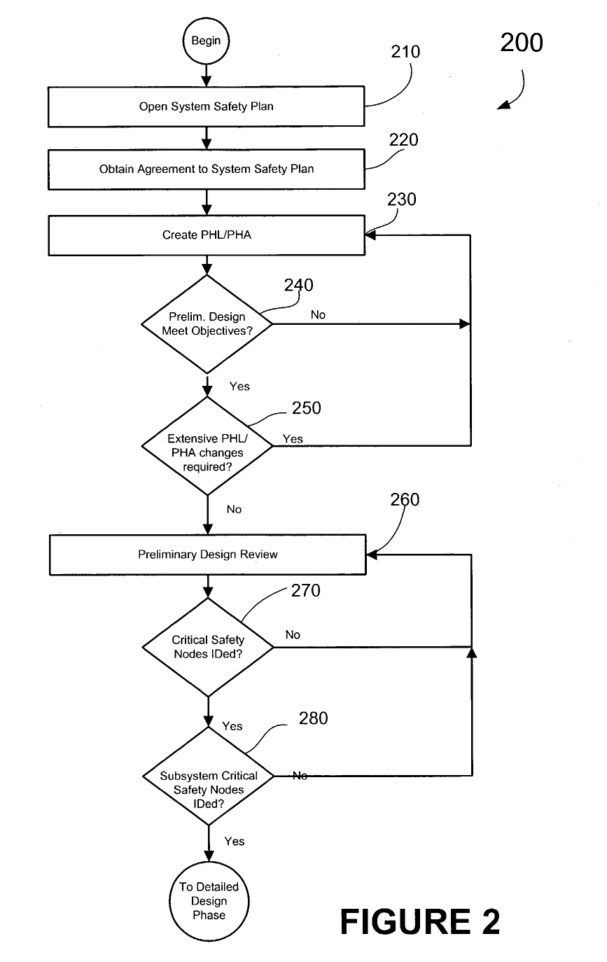

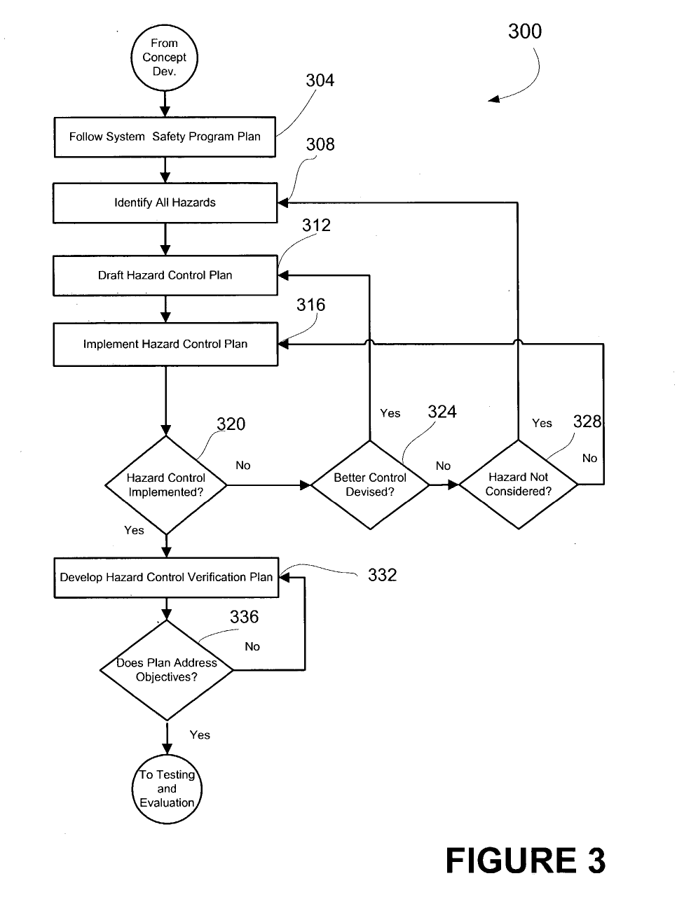

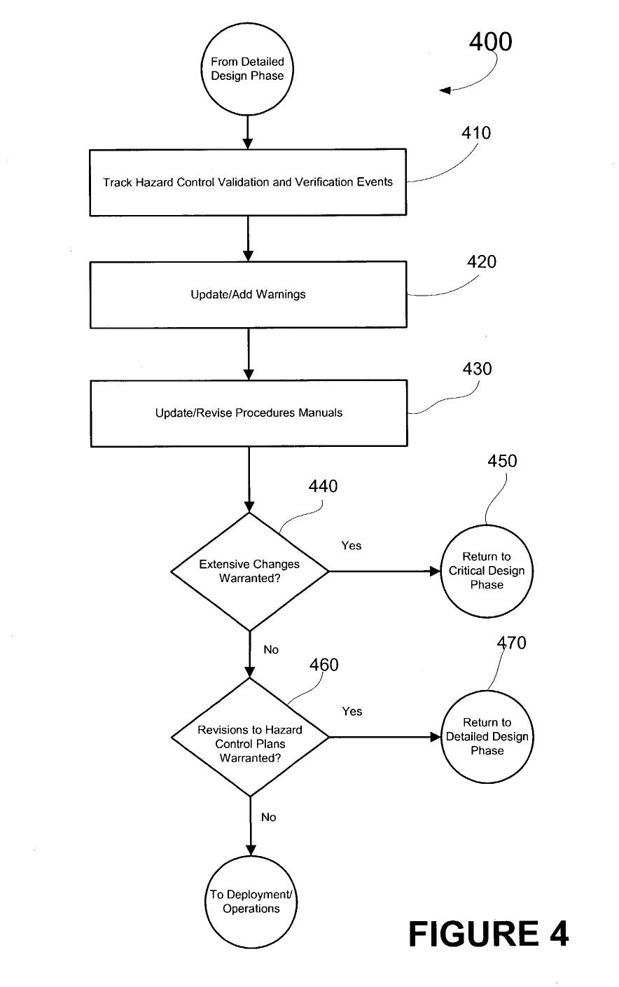

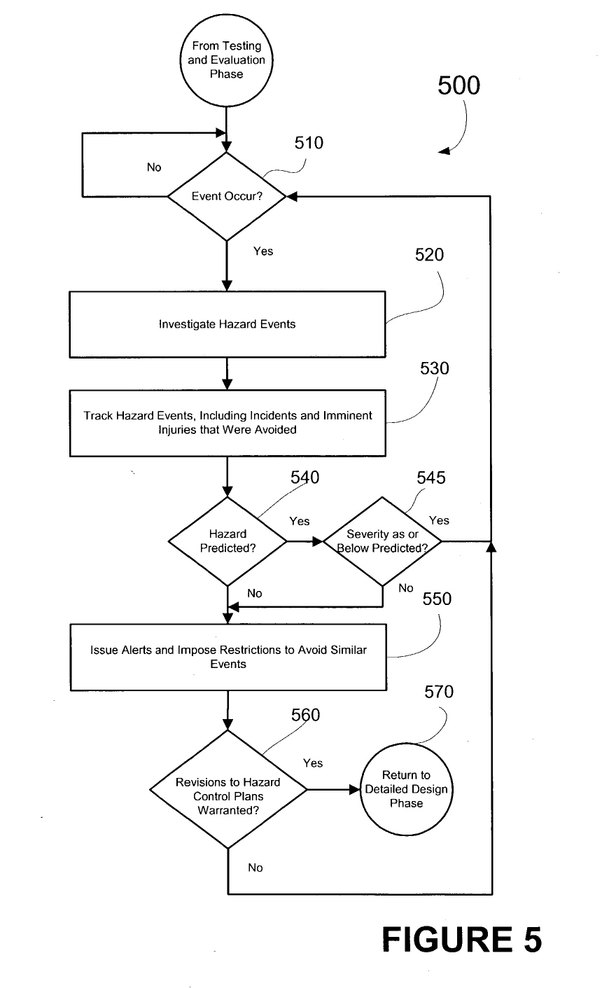

At a block 200, a first phase of the product evolution project is a concept development phase, which will be described in more detail with regard to FIG. 2. It is in the concept development phase at the block 200 that a system safety plan according to an embodiment of the present invention is first developed. At a block 300 is a detailed design phase, which will be described in more detail with regard to FIG. 3. During the detailed design phase at the block 300 the safety plan is further refined. At a block 400 is a testing and evaluation phase, which will be described in more detail with regard to FIG. 4. During the testing and evaluation phase at the block 400, the safety plan is enforced, tracked, and revised if necessary. At a block 500 is a deployment and operations phase, which will be described in more detail with regard to FIG. 5. In the deployment and operations phase at the block 500, the safety plan is further enforced, tracked, and revised as necessary.

FIG. 2 shows how the system safety plan is initially developed. At a block 210 a system safety plan is initiated or opened, thereby beginning the system safety process. At a block 220 agreement to the system safety plan is secured from all relevant personnel. Obtaining agreement to the system safety plan ensures that the relevant personnel recognize the importance of the system safety plan and will be committed to its adherence and performance. To further enhance this sense of commitment, agreement suitably is manifested by obtaining signatures of relevant stakeholders having an interest and a part in the planning process.

At a block 230 a preliminary hazard list (PHL) and/or preliminary hazard assessment (PHA) is created. It is during this preliminary hazard assessment that relevant personnel contemplate hazards that may be presented by the product evolution project throughout the design, creation, testing, deployment, and disposal phases of the project. Recognition of these hazards at this point in the product evolution project allows later steps in the project to be adjusted to avoid or ameliorate contemplated hazards. Performing the preliminary hazard assessment at this point can help to avoid significant process redesign and refitting at a later point, which may optimize design safety and avoid delays and wasted expenditures.

At a block 240 the development phase enters a critical design phase. The critical design phase is performed taking into account hazards identified during the preliminary hazard assessment. At a decision block 250, it is determined whether the critical design phase revealed that the preliminary hazard assessment necessitates substantial changes in the product evolution project. If so, the process reverts to the block 230 to re-create the preliminary hazard assessment to account for newly identified hazards. On the other hand, if no extensive changes are found to be needed at the decision block 250, the process continues with a preliminary design review at a block 260.

At a block 270 and a block 280, respectively, critical safety nodes and subcritical safety nodes are identified. Critical safety nodes are points in the further product evolution project in which safety critical functions must be handled or in which data must be used in safety critical functions. The significance of these points in the process requires very high attentiveness to the hazard control aspects, and very high integrity in applying hazard controls. It will be appreciated by one skilled in the art that such attentiveness and integrity may be costly because, for example, inspection and redundancy to achieve required safety objectives in functional operations. Accordingly, aspects of the project identified as critical nodes may be restricted to those aspects that are truly critical to maintain cost effectiveness. In a product evolution project, a certain rate of occurrence of potential hazards of an expected severity may be expected, establishing a mean expectancy level. Therefore, aspects of the project identified as critical safety nodes are those where hazards notably exceed an expected prevalence, and/or where hazards notably exceed an expected degree of severity. Recognizing that such points present greater prevalence or severity of hazards focuses the safety process on avoiding these possible hazards. In one presently preferred embodiment of the present invention, the preliminary design review at the block 260 continues until at least one critical safety node has been identified at a decision block 270.

Once at least one critical safety node has been identified at the decision block 270 the process continues with the identification of at least one subcritical safety node at a decision block 280. A subcritical safety node, analogous to a critical safety node, is a particular point within a critical safety node in which safety critical functions must be handled or in which data must be used in safety critical functions. In one presently preferred embodiment, the preliminary design review at the block 260 continues until at least one subcritical safety node has been identified at the decision block 280. In a preferred embodiment it is preferable to attempt to identify all critical safety nodes and subcritical safety nodes. A purpose of insisting upon identification of at least one critical safety node and at least one subcritical safety node is to assure attention to detail in attempting to identify all potential hazards. Once the identification has taken place at the decision blocks 270 and 280, the product evolution project transitions to the detailed design phase 300.

Referring to FIG. 3 and entering the detailed design phase 300, at a block 304 the system safety plan created thus far is put in place. As part of the detailed design phase at a block 308 an attempt is made to identify all potential hazards presented in the product evolution project. At a block 312, hazard controls are created for the hazards identified. At a block 316 the hazard control plan is implemented. At a decision block 320, it is determined whether the hazard controls previously created actually have been implemented. If not, it suitably may be determined at the decision block 324 that the hazard control was not implemented because a better hazard control has been devised. A better hazard control suitably is one that reduces the probability or severity of harm, or that suitably saves time or money while still preventing the potential hazard. If a more favorable hazard control has been devised, the hazard control plan is revised at the block 312. On the other hand, at a decision block 328 is determined whether a hazard control has not been implemented because of identification of a hazard that previously has not been recognized, and its impact on risk is assessed. If the hazard has not previously been recognized, the newly identified hazard is added to the list of identified hazards at the block 308. The hazard controls are then revised at the block 312 and evaluation of hazard control implementation continues at the block 316. If the hazard controls have not been implemented but not for these reasons, the process reverts to the block 316 until all hazard controls have been reevaluted and impact on risk assessed.

At a block 332, a hazard control verification plan is implemented. At the block 332 safety metrics procedures are used to quantitatively evaluate the system safety control plan and the various hazard controls imposed. In one presently preferred embodiment of the present invention, a risk assessment decision matrix is used. For a nonlimiting example, MIL-STD-882 type matrices suitably are used, the use of which is understood by those ordinarily skilled in the art. In short, such matrices allow for quantitative valuation of hazard probability and severity to allow for safety plan program assessment.

Table 1 shows an exemplary MIL-STD-882 risk assessment code table. As can be seen in Table 1, for each combination of probability of harm, listed as rows of the table, and severity of harm, listed as columns of the table, a numerical risk assessment code is assigned. The risk assessment codes are assigned for hazards before the system safety plan is implemented and/or reevaluated after the system safety plan has been implemented.

TABLE 1

SEVERITY

| | Cata- | Criti- | Mar- | Negli- |
|---|---|---|---|---|
| PROBABILITY | strophic | cal | ginal | gible |
| Frequent | 1 | 3 | 7 | 13 |
| Probable | 2 | 5 | 9 | 16 |
| Occasional | 4 | 6 | 11 | 18 |
| Remote | 8 | 10 | 14 | 19 |
| Improbable | 12 | 15 | 17 | 20 |

As can be seen in Table 1, the lesser the probability of harm and/or the lesser severity of the harm, the higher is the risk assessment code. For example, a hazard that is expected to be both frequent and catastrophic is assigned a risk assessment code of 1. On the other hand, a risk that is considered both improbable and negligible is assigned a risk assessment code of 20. Thus, the higher the risk assessment code assigned to each hazard, the less threatening is the hazard. Overall, in evaluating a system safety plan, the object is to achieve the highest possible score for each hazard and for the system safety plan as a whole.

Risk assessment codes suitably are assigned to evaluate a system safety plan before it is implemented and after it has been executed. For example, Table 2 shows a hypothetical risk assessment matrix for a first hypothetical system safety plan. In this plan, it is assumed that there will be 10 hazards of each type that might occur. The weighted score for the system safety plan is a total of all the foreseen harms multiplied by the risk assessment code for each as shown in Table 2.

TABLE 2

| | SEVERITY | | | |
|---|---|---|---|---|
| PROBABILITY | Catastrophic | Critical | Marginal | Negligible |
| Frequent | 10 × 1 = 10 | 10 × 3 = 30 | 10 × 7 = 70 | 10 × 13 = 130 |
| Probable | 10 × 2 = 20 | 10 × 5 = 50 | 10 × 9 = 90 | 10 × 16 = 160 |
| Occasional | 10 × 4 = 40 | 10 × 6 = 60 | 10 × 11 = 110 | 10 × 18 = 180 |
| Remote | 10 × 8 = 80 | 10 × 10 = 100 | 10 × 14 = 140 | 10 × 19 = 190 |
| Improbable | 10 × 12 = 120 | 10 × 15 = 150 | 10 × 17 = 170 | 10 × 20 = 200 |

Totaling the expected, weighted values results in an overall score of 2,100 for the first hypothetical system safety plan.

An advantageous aspect of this weighted assessment system is that it allows for the evaluation of alternative safety plans. Such a measurement suitably is made at a block 336. For the sake of example, if a second hypothetical safety plan resulted in a matrix where one of each type of hazard was completely avoided, the total weighted score would decline by 210 to 1,890. This is shown in Table 3 below.

TABLE 3

| | SEVERITY | | | |
|---|---|---|---|---|
| PROBABILITY | Catastrophic | Critical | Marginal | Negligible |
| Frequent | 9 × 1 = 9 | 9 × 3 = 27 | 9 × 7 = 63 | 9 × 13 = 117 |
| Probable | 9 × 2 = 18 | 9 × 5 = 45 | 9 × 9 = 81 | 9 × 16 = 144 |
| Occasional | 9 × 4 = 36 | 9 × 6 = 54 | 9 × 11 = 99 | 9 × 18 = 162 |
| Remote | 9 × 8 = 72 | 9 × 10 = 90 | 9 × 14 = 126 | 9 × 19 = 171 |
| Improbable | 9 × 12 = 108 | 9 × 15 = 135 | 9 × 17 = 153 | 9 × 20 = 180 |

In addition, each potential hazard that is completely eliminated from the matrix suitably is assigned an eliminated risk assessment code. The eliminated risk assessment code has value beyond that of a minimum risk assessment code. For example, in the previous tables, the minimum risk assessment code assigned is for an event is 20 for a hazard that considered “improbable” to occur and “negligible” in severity. Accordingly, assigning an eliminated risk assessment code of at least 21 to hazards actually foreclosed by hazard controls or other measures incorporated in the system safety plan allows for qualitative analysis of the system safety plan in a manner that considers elimination of hazards. Assigning a value for eliminated hazards, therefore, allows for a complete quantitative comparison of alternative system safety plans that might be under consideration. It will be appreciated that a risk assessment code system, including minimum risk assessment codes and eliminated risk assessment codes, can assign a low value to the most likely and severe hazards, as in the foregoing example, or a high value. Accordingly, a system safety plan can be evaluated when a highest possible overall total weighted score or a lowest possible overall total weighted score is desirable, respectively.

As can be shown in the foregoing example, the system safety plan can be more accurately quantitatively evaluated using the eliminated risk assessment code of 21. In Table 3, a total of 20 hazards have been eliminated, one from each assessment code category. Thus, the total score assigned the second hypothetical system safety plan is increased by 420, which is 21 times the 20 hazards avoided. Therefore, the total score assigned the second hypothetical system safety plan is 2,310. By making such risk assessment tables for alternative system safety plans, the alternative plans suitably are quantitatively compared even when some system safety plans may result in less probable but more severe hazards, or more probable but less severe hazards. Further, as will be appreciated by those skilled in the art, it may be difficult to assign risk assessment codes to certain types of events as to what constitutes catastrophic or what constitutes frequent. However, as long as the same risk assessment codes are consistently used in evaluating alternative plans, the scores will provide a sufficiently accurate relative assessment of the value of each alternative plan.

Such an evaluation of alternative plans suitably is made at the decision block 336. If the system safety plan devised achieves its objectives, whether that be to choose the best safety plan currently available, to be better than past safety records, or another reason, assignment of such risk assessment codes makes quantitative analysis of such plans possible.

FIG. 4 shows how an embodiment of the present invention is incorporated in the testing and evaluation phase 400 of a product evolution project. The use of risk assessment codes, as previously described, allows system safety plans to be assessed as they are implemented against their own projections in addition to comparing conceived alternatives. At a block 410, tracking of the system safety plan is initiated. Hazards are logged in a hazard database from which the entire system safety plan suitably is evaluated. As the testing and evaluation phase continues, at a block 420 warnings suitably are added or amended to reflect previously-unforeseen hazards and/or better ways of avoiding hazards. Similarly, at a block 430 manuals outlining testing, evaluation, and/or safety procedures are updated and amended to attempt to avoid hazards that previously were unforeseen or for which better hazard controls have been conceived. At a decision block 440, if it is determined that extensive changes in the overall product evolution project as indicated by changes needed in warnings and/or manuals, the entire product evolution project suitably is remanded at a block 450 to the critical design phase at the block 240 (FIG. 2) to revamp the project to meet safety mandates. On the other hand, if it is determined that revisions to the system safety control plan is warranted at a decision block 460, the product evolution project suitably is remanded at a block 470 to the detailed design phase 300 (FIG. 3). Resuming the detailed design phase 300, hazard identification and hazard control planning measures as previously described suitably are revisited to assure adequate safety within the current product evolution project.

After testing and evaluation, the deployment and operations phase 500 commences. To track the success of the system safety plan, and referring now to FIG. 5, at a decision block 510 the current phase is continually monitored. At the decision block 510 the current phase repeats continually until a hazard event, such has a mishap or a near mishap, has transpired. Once a hazard event has transpired, at a block 520 the hazard event is investigated and studied to determine what happened. At a block 530, the results of the investigation at the block 520 are logged and tracked. The hazard event is logged regardless of whether the hazard event resulted in an mishap or resulted in an imminent mishap fortuitously being avoided. At a decision block 540, it is determined whether the hazard is one that was predicted. If the hazard was of a type previously predicted, then, at a decision block 545 it is determined if the severity of the hazard was at or below the level predicted. If the hazard was expected and the level of severity was expected, the project resumes and monitoring of hazard events continues at the decision block 510. On the other hand, if at the decision block 540 it is determined that the hazard was not of a type predicted or at the decision block 545 the severity of the hazard was greater than expected, alerts are issued and/or procedures restricted as needed to avoid similar events at a block 550. At a decision block 560, considering hazard events that have occurred and/or warnings or restrictions imposed, it suitably may be determined that the system safety plan should be revised. If so, at a block 570, detailed design is resumed to revise the system safety plan. If not, the deployment and operations phase resumes at the decision block 510 until a hazard event occurs.

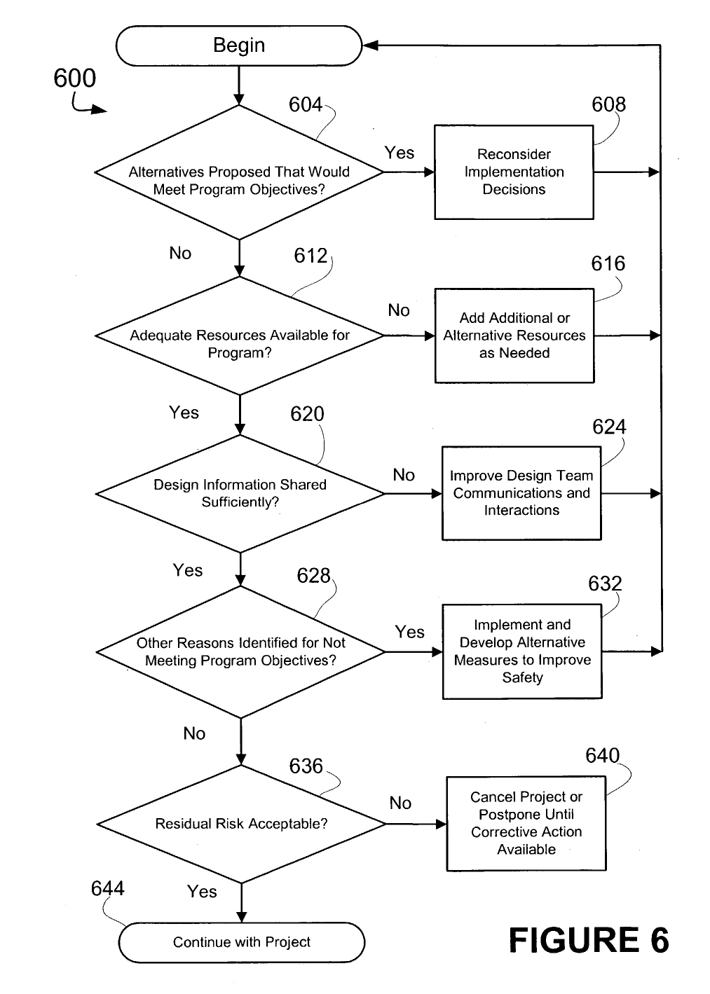

FIG. 6 is a flowchart of a review process 600 undertaken when system safety program objectives are not met. This is a potentially ongoing, recurring process, and thus is not readily assignable to any single phase of the program or at any particular point in the program. An object of the review process 600 depicted in FIG. 6 is correction and improvement of a system safety plan taking advantage of the safety metric process previously described. Once a hazard event has occurred resulting in a mishap or a near mishap causing the system safety plan to fall short of its objectives or the program otherwise has had undesired safety results, the review process 600 is initiated. The review and correction process 600 represented by the flowchart also can be conceived as a checklist of safety measures.

At a block 604 it is considered whether alternative hazard controls had been proposed other than those previously implemented that could have avoided the hazard event. If so, at a block 608 decisions regarding implementation of controls are reconsidered, and alternative measures are put into place to revise the system safety plan. At a block 612 it is considered whether adequate or appropriate resources were available for implementing and enforcing the system safety program and could have avoided the hazard event. If not, at a block 616 additional or alternative resources are made available to ensure appropriate emphasis is given to safety issues. At a block 620 it is considered whether design information was shared sufficiently and whether a failure to share design information resulted in the hazard event. If design information was not sufficiently shared, at a block 624 measures are taken to improve design team communication and interaction to avert similar hazard events. Having considered the specific issues presented at blocks 604, 612, and 620, at a block 628 it is considered whether there are other reasons for not meeting system safety program objectives or for the occurrence of other unsatisfactory safety issues. If so, those reasons are considered at a block 632 and alternative safety measures are developed and implemented to improve safety. From the flowchart of the review process 600, it will be appreciated that the process is iterative and will continue through these steps previously discussed until the issues presented at blocks 604, 612, 620, and 628 have been addressed at blocks 608, 616, 624, and 632, respectively.

Once evaluation and consideration of safety issues has been completed, at a block 636 it is considered whether any remaining safety risks are acceptable. If so, the project continues at a block 644. If any remaining safety concerns are not acceptable, at a block 640 the project is postponed or cancelled until corrective action is available and can be implemented.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method for employing system safety metrics in a product evolution project, the method comprising:
opening a system safety plan;
performing a preliminary hazard assessment to identify potential hazards present in a product evolution project;
creating a hazard control for the potential hazards to minimize a risk associated with the potential hazards;
creating a metric program measurement standard to evaluate the hazard control plan;
investigating hazard events; and
tracking hazard events such that the system safety plan is assessed against the metric program measurement standard.

2. The method of claim 1, wherein the product evolution project includes at least one of preliminary design, detailed design, manufacture, installation, deployment, operation, and disposal of a product.

3. The method of claim 1, wherein the opening of the system safety plan includes obtaining assent by relevant planning personnel to the system safety plan.

4. The method of claim 3, wherein the assent obtained is demonstrated by obtaining signatures of the relevant planning personnel.

5. The method of claim 1, further comprising refining the system safety plan during successive phases of the product evolution project to account for previously-unforeseen hazards.

6. The method of claim 1, further comprising reinitiating the preliminary hazard assessment if extensive changes are to be made in the preliminary hazard assessment upon progressing to a next product evolution phase.

7. The method of claim 1, wherein at least one critical safety node is identified in the product evolution project, wherein the critical safety node is a step in which safety critical functions must be handled or in which data must be used in safety critical functions.

8. The method of claim 7, wherein at least one subcritical safety node is identified, wherein the subcritical safety node is an aspect of the critical safety node in which safety critical functions must be handled or in which data must be used in safety critical functions.

9. The method of claim 1, further comprising monitoring the system safety plan for implementation of controls included in the hazard control plan.

10. The method of claim 1, wherein the hazard events include events resulting in injuries and events in which imminent injuries were avoided.

11. The method of claim 1, further comprising creating a hazard-tracking database to maintain data on the hazard events.

12. The method of claim 1, further comprising revising the hazard control plan when an unforeseen hazard is encountered.

13. The method of claim 1, further comprising revising the hazard control plan when a new control is identified that will reduce one of probability of a hazard event or severity of a hazard event.

14. The method of claim 1, further comprising amending warnings to avoid future hazard events similar to a previously-occurring actual hazard event that was not foreseen before it occurred.

15. The method of claim 1, further comprising amending manuals to avoid future hazard events similar to a previously-occurring actual hazard event that was not foreseen before it occurred.

16. The method of claim 1, wherein the metric program measurement standard includes a risk assessment decision matrix to assess risks on the basis of both probability of mishap and severity of mishap.

17. The method of claim 16, wherein an eliminated risk assessment code is assigned for hazards eliminated by the system safety plan, the eliminated risk assessment code having a value beyond that of a minimum risk assessment code.

18. The method of claim 17, wherein assignment of the eliminated risk assessment code to the hazards eliminated by the system safety plan allows for quantitative assessment of the system safety plan accounting for the hazards eliminated by the system safety plan.

19. The method of claim 16, further comprising assessing alternative system safety plans with the risk assessment decision matrix.

20. The method of claim 1, further comprising a review process, the review process being initiated upon the occurrence of one of the system safety plan failing to meet objectives or the product evolution project yielding safety concerns not considered in the system safety plan.

21. The method of claim 20, wherein implementation decisions are reconsidered when alternative safety measures have been proposed that facilitate meeting system safety plan objectives and current safety measures have failed to meet system safety plan objectives.

22. The method of claim 20, wherein one of additional resources or alternative resources are made available to ensure safety when existing resources have failed to meet system safety plan objectives.

23. The method of claim 20, wherein improvements in design team communication and interaction is sough when existing communication and interaction has failed to meet system safety plan objectives.

24. The method of claim 20, wherein alternative safety measures are developed when currently conceived safety measures have failed to meet system safety plan objectives.

25. The method of claim 20, wherein the product evolution project is one of postponed or canceled when corrective safety measures are not currently available that would result in acceptable residual risks.

26. A method for employing system safety metrics in a product evolution project, the method comprising:
opening a system safety plan;
performing a preliminary hazard assessment to identify potential hazards present in a product evolution project;
creating a hazard control for the potential hazards to minimize a risk associated with the potential hazards;
refining the system safety control plan during successive phases of the product evolution project to account for previously-unforeseen hazards.
creating a metric program measurement standard to evaluate the system safety plan, wherein the metric program measurement standard includes a risk assessment decision matrix to assess risks on the basis of both probability of mishap and severity of mishap;
investigating hazard events; and
tracking hazard events such that the system safety plan is assessed against the metric program measurement standard.

27. The method of claim 26, wherein the product evolution project includes at least one of preliminary design, detailed design, manufacture, installation, deployment, operation, and disposal of a product.

28. The method of claim 26, wherein the opening of the system safety plan includes obtaining assent by relevant planning personnel to the system safety plan.

29. The method of claim 28, wherein the assent obtained is demonstrated by obtaining signatures of the relevant planning personnel.

30. The method of claim 26, further comprising reinitiating the preliminary hazard assessment if extensive changes are to be made in the preliminary hazard assessment upon progressing to a next product evolution phase.

31. The method of claim 26, wherein at least one critical safety node is identified in the product evolution project, wherein the critical safety node is a step in which safety critical functions must be handled or in which data must be used in safety critical functions.

32. The method of claim 31, wherein at least one subcritical safety node is identified, wherein the subcritical safety node is an aspect of the critical safety node in which safety critical functions must be handled or in which data must be used in safety critical functions.

33. The method of claim 26, further comprising monitoring the system safety plan for implementation of controls included in the system safety plan.

34. The method of claim 26, wherein the hazard events include events resulting in injuries and events in which imminent injuries were avoided.

35. The method of claim 26, further comprising creating a hazard-tracking database to maintain data on the hazard events.

36. The method of claim 26, further comprising revising the hazard control plan when an unforeseen hazard is encountered.

37. The method of claim 26, further comprising revising the hazard control plan when a new control is identified that will reduce one of probability of mishap or severity of mishap.

38. The method of claim 26, further comprising amending warnings to avoid future hazard events similar to a previously-occurring actual hazard event that was not foreseen before it occurred.

39. The method of claim 26, further comprising amending manuals to avoid future hazard events similar to a previously-occurring actual hazard event that was not foreseen before it occurred.

40. The method of claim 26, wherein an eliminated risk assessment code is assigned for hazards eliminated by the system safety plan, the eliminated risk assessment code having a value beyond that of a minimum risk assessment code.

41. The method of claim 40, wherein assignment of the eliminated risk assessment code to the hazards eliminated by the system safety plan allows for quantitative assessment of the system safety plan accounting for the hazards eliminated by the system safety plan.

42. The method of claim 26, further comprising assessing alternative system safety plans with the risk assessment decision matrix.

43. The method of claim 26, further comprising a review process, the review process being initiated upon the occurrence of one of the system safety plan failing to meet objectives or the product evolution project yielding safety concerns not considered in the system safety plan.

44. The method of claim 43, wherein implementation decisions are reconsidered when alternative safety measures have been proposed that facilitate meeting system safety plan objectives and current safety measures have failed to meet system safety plan objectives.

45. The method of claim 43, wherein one of additional resources or alternative resources are made available to ensure safety when existing resources have failed to meet system safety plan objectives.

46. The method of claim 43, wherein improvements in design team communication and interaction is sough when existing communication and interaction has failed to meet system safety plan objectives.

47. The method of claim 43, wherein alternative safety measures are developed when currently conceived safety measures have failed to meet system safety plan objectives.

48. The method of claim 43, wherein the product evolution project is one of postponed or canceled when corrective safety measures are not currently available that would result in acceptable residual risks.

49. A safety metrics system for use with a product evolution project, the system comprising:
a system safety plan;
a preliminary hazard assessment to identify potential hazards present in a product evolution project;
a hazard control plan for preventing the potential hazards, the hazard control plan identifying at least one node in the product evolution project where safety is implemented to avoid the potential hazards;
a metric program measurement standard to evaluate the hazard control plan;
hazard event investigations; and
hazard event tracking such that the hazard control plan are assessed against the metric program measurement standard.

50. The system of claim 49, further comprising assent gathering to gain concurrence of relevant planning personnel to the system safety plan.

51. The system of claim 49, wherein the assent gathering includes obtaining signatures of the relevant planning personnel.

52. The system of claim 49, wherein the preliminary hazard assessment is reinitiated if extensive changes are made in the preliminary hazard assessment upon progressing to a next product evolution phase.

53. The system of claim 49, further comprising refinement of the hazard control plan during successive phases of the product evolution project to account for previously-unforeseen hazards.

54. The system of claim 49, further comprising identification of at least one critical safety node in the product evolution project, wherein the critical safety node is a step in which safety critical functions must be handled or in which data must be used in safety critical functions.

55. The method of claim 54, wherein at least one subcritical safety node is identified, wherein the subcritical safety node is an aspect of the critical safety node in which safety critical functions must be handled or in which data must be used in safety critical functions.

56. The system of claim 49, wherein the system safety plan is monitored for implementation of controls included in the hazard control plan.

57. The system of claim 49, wherein the hazard events include events resulting in injuries and events in which imminent injuries were avoided.

58. The system of claim 49, further comprising a hazard-tracking database to maintain data on the hazard events.

59. The system of claim 49, wherein the hazard control plan is revised when an unforeseen hazard is encountered.

60. The method of claim 49, further comprising revising the hazard control plan when a new control is identified that will reduce one of probability of mishap or severity of mishap.

61. The system of claim 49, wherein warnings included as part of the hazard controls are amended to avoid future hazard events similar to a previously-occurring actual hazard event that was not foreseen before it occurred.

62. The system of claim 49, wherein manuals are amended to avoid future hazard events similar to a previously-occurring actual hazard event that was not foreseen before it occurred.

63. The system of claim 49, wherein the metric program measurement standard includes a risk assessment decision matrix to assess risks on the basis of both probability and consequence.

64. The system of claim 49, wherein an eliminated risk assessment code is assigned for hazards eliminated by the system safety plan, the eliminated risk assessment code having a value beyond that of a minimum risk assessment code.

65. The system of claim 64, wherein assignment of the eliminated risk assessment code to the hazards eliminated by the system safety plan allows for quantitative assessment of the system safety plan accounting for the hazards eliminated by the system safety plan.

66. The system of claim 49, wherein the risk assessment decision matrix is used to assess alternative system safety plans.

67. The system of claim 49, further comprising a review process, the review process being initiated upon the occurrence of one of the system safety plan failing to meet objectives or the product evolution project yielding safety concerns not considered in the system safety plan.

68. The system of claim 67, wherein implementation decisions are reconsidered when alternative safety measures have been proposed that facilitate meeting system safety plan objectives and current safety measures have failed to meet system safety plan objectives.

69. The system of claim 67, wherein one of additional resources or alternative resources are made available to ensure safety when existing resources have failed to meet system safety plan objectives.

70. The system of claim 67, wherein improvements in design team communication and interaction is sough when existing communication and interaction has failed to meet system safety plan objectives.

71. The system of claim 67, wherein alternative safety measures are developed when currently conceived safety measures have failed to meet system safety plan objectives.

72. The system of claim 67, wherein the product evolution project is one of postponed or canceled when corrective safety measures are not currently available that would result in acceptable residual risks.
